(19) United States
(12) Patent Application Publication
(10) Pub. No.: US 2015/0114583 A1
(43) Pub. Date: Apr. 30, 2015

(54) HOT MELT ADHESIVE

(71) Applicant: HENKEL AG & CO. KGAA, Duesseldorf (DE)

(72) Inventor: Ai Takamori, Osaka (JP)

(21) Appl. No.: 14/583,873

(22) Filed: Dec. 29, 2014

Related U.S. Application Data
(63) Continuation of application No. PCT/JP2013/068312, filed on Jun. 27, 2013.

(30) Foreign Application Priority Data
Jun. 28, 2012 (JP) 2012-144973

(51) Int. Cl. C09J 123/20

(52) U.S. Cl. CPC C09J 123/20
USPC 162/164.7; 524/513

(57) ABSTRACT

Disclosed is a hot melt adhesive comprising: (A) an ethylene-based copolymer; (B) a polyester polyol; and (C) a wax, wherein the wax (C) includes both (C1) a Fischer-Tropsch wax and (C2) a petroleum wax. The hot melt adhesive can be applied at a low temperature, and also has a suitably long open time and is excellent in adhesion to a paper. The hot melt adhesive can be used preferably for producing a paper product. A paper product obtainable by using the hot melt adhesive is also provided.

### CROSS-REFERENCE TO RELATED APPLICATIONS

This application is a continuation of International Patent Application No. PCT/JP2013/068312 filed Jun. 27, 2013, which claims priority to Japanese Patent Application No. 2012-144973 filed on Jun. 28, 2012 in Japan, the contents of both of which are incorporated herein by reference.

### FIELD OF INVENTION

The present invention relates to a hot melt adhesive. Furthermore, the present invention relates to a paper product obtainable by using the hot melt adhesive.

### BACKGROUND OF THE INVENTION

A hot melt adhesive is a solvent-free adhesive and has features enabling of instant bonding and high-speed bonding since adhesion of the adhesive is exhibited after the adhesive is heated, melted, applied to an adherend and then solidified by being cooled. For example, the hot melt adhesive is now widely used in paper processing, woodworking, sanitary material and electronic fields.

There have been used commonly, as a base polymer of the hot melt adhesive, ethylene-based copolymers such as an ethylene-vinyl acetate copolymer (hereinafter also referred to as “EVA”) and an ethylene-ethyl acrylate copolymer (hereinafter also referred to as “EEA”); olefin-based resins such as polyethylene, polypropylene and amorphous polyalphaolefin (hereinafter also referred to as “APAO”); synthetic rubbers such as a styrene-based block copolymer (for example, a styrene-isoprene-styrene-based block copolymer (hereinafter also referred to as “SIS”), a styrene-butadiene-styrene-based block copolymer (hereinafter also referred to as “SBS”) and a hydrogenated product thereof; polyurethanes; and the like, according to the intended use.

Among these hot melt adhesives, a hot melt adhesive containing the ethylene-based copolymer as a base polymer is frequently used in the paper processing field such as bookbinding and packing, film processing, and the woodworking field.

When the ethylene-based hot melt adhesive is applied to an adherend such as a paper or a film, a special coating applicator called a hot melt applicator is frequently used. The hot melt applicator includes a nozzle which is a dispense port, and the hot melt adhesive is heated to about 120 to 190° C., dispensed from a nozzle tip and applied to an adherend.

Japanese Publication Nos. 07-150123, 2008-527067, and 2008-214539 disclose hot melt adhesives containing an ethylene-based copolymer as a base polymer.

Japanese Publication No. 07-150123 discloses a hot melt adhesive containing an ethylene/ethyl acrylate as one component (see claim 1 and Table 1 of Japanese Publication No. 07-150123). The same document discloses that a hot melt adhesive having excellent adhesion to a polyolefin-based resin is obtainable by mixing an ethylene/ethyl acrylate, a specific polyester, and a compatibilizing agent (see [0006], of Japanese Publication No. 07-150123).

Japanese Publication No. 2008-527067 and 2008-214539 disclose hot melt adhesives containing two components of an ethylene/olefin copolymer and an ethylene/carboxylic acid ester copolymer (see claim 1 and Table 1 of Japanese Publication No. 2008-527067, Table 1 of Japanese Publication No. 2008-214539). Both the documents disclose an effect that stringing (or stringing property) of the hot melt adhesive is reduced (or the adhesive is excellent in stringing resistance), the stringing being generated when the adhesive is applied to an adherend (see Table 1 and [0038] of Japanese Publication No. 2008-527067, Table 1 and [0025] to [0027] of Japanese Publication No. 2008-214539).

Recently, various performances, particularly low temperature coatability, have been required to an ethylene-based hot melt adhesive. Application of a hot melt adhesive to an adherend (or base material) at high temperature is not preferable since it may sometimes exert an adverse influence on a coating line according to the type of the adherend and/or the composition of the adhesive. Therefore, progress has been made in the development of a hot melt adhesive which can be applied to an adherend at low temperature of about 120 to about 140° C.

The hot melt adhesive of Japanese Publication No. 07-150123 is heated to 150° C. and then bonded to an adherend (see [0024] of Japanese Publication No. 07-150123). The hot melt adhesive of Japanese Publication No. 2008-527067 is ejected through a nozzle at 170° C. or 180° C. (see [0037] of Japanese Publication No. 2008-527067), and the hot melt adhesive of Japanese Publication No. 2008-214539 is ejected through a nozzle at 180° C. (see [0021] of Japanese Publication No. 2008-214539). Each of the hot melt adhesives of Japanese Publication Nos. 07-150123, 2008-527067, and 2008-214539 is excellent in thermal stability since they are applied at high temperature, but is not suited for low temperature (120 to 140° C.) coating.

Taking wettability to the adherend and coatability to an adherend having a complicated shape into consideration, it is required for the hot melt adhesive to have a suitably long open time. When the open time of the hot melt adhesive is too short, it becomes difficult to bond.

Recently, a carton, of which surface is coated with a chemical so as to impart a luxurious feel to wrapping of products, has often been used for wrapping products. Therefore, it is necessary for the hot melt adhesive that the adhesive has a certain degree of adhesion to the coated surface of the carton and the adhesion is excellent in a wide temperature range.

In the adhesive industry, there is an urgent need to develop an ethylene-based hot melt adhesive which can be applied at a low temperature, and also has a suitably long open time and is excellent in adhesion to a paper.

### SUMMARY OF THE INVENTION

An object of the present invention is to provide a hot melt adhesive which can be applied at a low temperature, and also has a suitably long open time and is excellent in adhesion to a paper. Another object thereof is to provide a paper product obtainable by using the hot melt adhesive.

The present inventors have intensively studied and found that the above-mentioned object can be achieved by mixing a specific polyester and a specific wax with an ethylene-based copolymer, and thus the present invention has been completed.

Namely, in an aspect, the present invention provides a hot melt adhesive comprising: (A) an ethylene-based copolymer; (B) a polyester polyol; and (C) a wax, wherein the wax (C) includes both (C1) a Fischer-Tropsch wax and (C2) a petroleum wax.

In a preferred embodiment, the present invention provides a hot melt adhesive, wherein the petroleum wax (C2) includes at least one selected from a paraffin wax and a microcrystalline wax.

In another preferred embodiment, the present invention provides a hot melt adhesive, wherein the ethylene-based copolymer (A) includes at least one selected from a copolymer of ethylene/olefin having 3-20 carbons and a copolymer of ethylene/carboxylic acid ester.

In another aspect, the present invention provides a paper product obtainable by using the above hot melt adhesive.

### DETAILED DESCRIPTION OF THE INVENTION

Since the hot melt adhesive according to the present invention includes (A) an ethylene-based copolymer; (B) a polyester polyol; and (C) a wax, and the wax (C) includes both (C1) a Fischer-Tropsch wax and (C2) a petroleum wax, the hot melt adhesive can be applied at low temperature, and also has a suitably long open time and is excellent in adhesion to a paper. The hot melt adhesive can be preferably used as a hot melt adhesive for paper. Recently, a carton for wrapping products has often been coated with a chemical. The hot melt adhesive according to the present invention also exhibits excellent adhesion to the special carton.

When the petroleum wax (C2) includes at least one selected from a paraffin wax and a microcrystalline wax, low temperature coatability, open time and adhesion to a paper of the hot melt adhesive according to the present invention are more improved in a well-balanced manner.

When the ethylene-based copolymer (A) includes at least one selected from a copolymer of ethylene/olefin having 3-20 carbons and a copolymer of ethylene/carboxylic acid ester, low temperature coatability, open time and adhesion to a paper of the hot melt adhesive according to the present invention are more improved in a well-balanced manner. Therefore, the hot melt adhesive is more suited as a hot melt adhesive for paper processing.

Since the paper product according to the present invention is producible by using the above-mentioned hot melt adhesive, it is produced by a low temperature coating line. Therefore, an adverse influence is not exerted on a coating line of the hot melt adhesive and a paper as a base material. Furthermore, since the hot melt adhesive has a suitably long open time, it is possible to provide some margin for a step of producing a paper product by bonding.

As used herein, the “open time” means a time until it is impossible for a hot melt adhesive to wet a surface of an adherend because of disappearance of fluidity of the adhesive after application of the adhesive to the adherend.

The hot melt adhesive according to the present invention comprises three components: (A) an ethylene-based copolymer; (B) a polyester polyol; and (C) a wax, and the wax (C) includes both (C1) a Fischer-Tropsch wax and (C2) a petroleum wax.

As used herein, the “hot melt adhesive” means an adhesive which is solid at normal temperature and has fluidity by being heated and melted and, for example, an adhesive which can be applied to a target such as a base material or an adherend, and also can be solidified and bonded by being cooled.

In the present invention, the “(A) ethylene-based copolymer” means a copolymer of ethylene with another polymerizable monomer, and is not particularly limited as long as the objective hot melt adhesive according to the present invention is obtainable.

In the present invention, a distinction is made between the ethylene-based copolymer (A) and the wax (C) by comparing the weight average molecular weight. The ethylene-based copolymer (A) has a weight average molecular weight of 10,000 or more, while the wax (C) has a weight average molecular weight of less than 10,000. The weight average molecular weight means a value obtained by gel permeation chromatography (GPC) in terms of polystyrene standards. Specifically, the weight average molecular weight can be measured by the following GPC apparatus and measurement method. HCL-8220GPC manufactured by TOSOH CORPORATION is used as the GPC apparatus, and RI is used as a detector. Two TSKgel SuperMultipore HZ-M manufactured by TOSOH CORPORATION are used as a GPC column. A sample is dissolved in tetrahydrofuran, and the solution is allowed to flow at a flow rate of 0.35 ml/min and a column temperature of 40° C. to obtain a measured value of a molecular weight. By using a calibration curve using polystyrene having a monodispersed molecular weight as a standard substance, the measured molecular weight is converted to obtain the objective weight average molecular weight.

The “other polymerizable monomer” means a monomer (excluding ethylene) having a double bond between carbon atoms which enables addition polymerization with ethylene.

Specific examples of the “other polymerizable monomer” include “olefin-based hydrocarbon excluding ethylene”, “carboxylic acid having an ethylenic double bond”, “carboxylic anhydride having an ethylenic double bond”, and “carboxylic acid ester having an ethylenic double bond”.

The “olefin-based hydrocarbon excluding ethylene” (hereinafter also referred to as “olefin”) is more preferably an olefin having 3-20 carbons. Specific examples of the “olefin having 3-20 carbons” include propylene, 1-butene, 1-pentene, 1-hexene, 1-heptene, 1-octene, 1-nonene, 1-decene, cis-2-butene, trans-2-butene, isobutylene, cis-2-pentene, trans-2-pentene, 3-methyl-1-butene, 2-methyl-2-butene, and 2,3-dimethyl-2-butene.

The “carboxylic acid having an ethylenic double bond” (hereinafter also referred to as “carboxylic acid”) is a compound having an ethylenic double bond and a carboxyl group, and there is no particular limitation as long as the hot melt adhesive according to the present invention can be obtained. Specific examples thereof include oleic acid, linoleic acid, maleic acid, itaconic acid, succinic acid, acrylic acid, and methacrylic acid.

The “carboxylic anhydride having an ethylenic double bond” (hereinafter also referred to as “carboxylic anhydride”) is a compound having a carboxylic anhydride group in which two carboxyl groups undergo dehydration condensation, and there is no particular limitation as long as the hot melt adhesive according to the present invention can be obtained. Specific examples thereof include maleic anhydride and the like.

Examples of the “carboxylic acid ester having an ethylenic double bond” (hereinafter also referred to as “carboxylic acid ester”) include (meth)acrylic acid esters such as methyl (meth)acrylate, butyl (meth)acrylate, and 2-ethylhexyl (meth)acrylate, and vinyl carboxylates and allyl esters, such as vinyl acetate and allyl acetate.

These “other polymerizable monomers” can be used alone or in combination.

As used herein, when the other polymerizable monomer is an “olefin-based hydrocarbon excluding ethylene”, the ethylene-based copolymer (A) includes “(A1) a copolymer of ethylene with olefin”. When the other polymerizable monomer is a “carboxylic acid having an ethylenic double bond”, the ethylene-based copolymer (A) includes “(A2) a copolymer of ethylene with carboxylic acid”. When the other polymerizable monomer is a “carboxylic anhydride having an ethylenic double bond”, the ethylene-based copolymer (A) includes “(A3) a copolymer of ethylene with carboxylic anhydride”. When the other polymerizable monomer is a “carboxylic acid ester having an ethylenic double bond”, the ethylene-based copolymer (A) includes “(A4) a copolymer of ethylene with carboxylic acid ester”.

In the present invention, the ethylene-based copolymer (A) preferably includes (A1) a copolymer of ethylene with olefin. Therefore, the “other polymerizable monomer” preferably contains an “olefin-based hydrocarbon excluding ethylene”, more preferably contains an “olefin having 3-20 carbons”, particularly preferably contains at least one selected from propylene, butene, and octene, and most preferably contains octene.

The copolymer of, ethylene with olefin (A1) preferably includes a copolymer of ethylene with olefin having 3-20 carbons (hereinafter also referred to as “ethylene/olefin having 3-20 carbons copolymer”). More specifically, the copolymer more preferably includes, for example, at least one selected from a copolymer of ethylene with octene, a copolymer of ethylene with propylene and 1-butene, a copolymer of ethylene with propylene, and a copolymer of ethylene with butene, particularly preferably includes at least one selected from a copolymer of ethylene with octene, and a copolymer of ethylene with propylene and 1-butene, and most preferably includes a copolymer of ethylene with octene. These copolymers of ethylene with olefin (A1) can be used alone or in combination. Commercially available products can be used as the copolymer of ethylene with olefin (A1).

Examples of the “copolymer of ethylene with propylene and 1-butene” include VESTOPLAST 703 (trade name), VESTOPLAST 708 (trade name) and the like, manufactured by EVONIK DEGUSSA.

Examples of the “copolymer of ethylene with octene” include AFFINITY GA1900 (trade name), AFFINITY GA1950 (trade name), AFFINITY EG8185 (trade name), AFFINITY EG8200 (trade name), ENGAGE 8137 (trade name), ENGAGE 8180 (trade name), ENGAGE 8400 (trade name) and the like, manufactured by The Dow Chemical Company.

Examples of the “copolymer of ethylene with propylene” include Eastoflex E1016PL-1 and the like, manufactured by Eastman Chemical Company.

In the present invention, the ethylene-based copolymer (A) may contain at least one selected from the above-mentioned (A2) to (A4), in addition to (A1) or in place of (A1). Among (A2) to (A4), (A4) is more preferable. Commercially available products can be used as (A2) to (A4) and can be used alone or in combination.

Examples of (A2) include an ethylene/acrylic acid copolymer, an ethylene/methacrylic acid copolymer, and an ethylene/hydroxystearic acid copolymer.

Examples of (A3) include an ethylene/maleic anhydride copolymer.

Examples of (A4) include an ethylene/vinyl acetate copolymer, an ethylene/methyl methacrylate copolymer, an ethylene/2-ethylhexyl acrylate copolymer, an ethylene/butyl acrylate copolymer, an ethylene/butyl methacrylate copolymer and the like. (A4) is more preferably an ethylene/vinyl acetate copolymer and/or an ethylene/methyl methacrylate copolymer, and particularly preferably an ethylene/vinyl acetate copolymer.

The ethylene-based copolymer (A) preferably has a melt flow rate of 10 to 2,000 g/10 minutes, particularly preferably 100 to 1,500 g/10 minutes, and most preferably 200 to 1,200 g/10 minutes.

When the melt flow rate is from 10 to 2,000 g/10 minutes, a hot melt adhesive having more excellent balance among adhesive force, heat resistance, and low temperature coatability is obtained.

As used herein, the “melt flow rate” means an index which indicates fluidity of a resin and is determined by heating and pressurizing a given amount of a synthetic resin at a predetermined temperature (190° C.) in a cylindrical vessel heated by a heater, and measuring the amount of the resin extruded through an orifice (nozzle) provided on the bottom of the vessel per 10 minutes. Unit of g/10 minutes is used. An extrusion-type plastometer defined in JIS K6769 is used as a testing machine, and the measurement is performed by the measurement method defined in JIS K7210.

The ethylene-based copolymer (A) according to the present invention preferably includes at least one selected from (A1) to (A4) each having a melt flow rate of 200 to 1,200 g/10 minutes, and more preferably includes at least one selected from (A1) and (A4) each having a melt flow rate of 200 to 1,200 g/10 minutes.

Examples of (A1) having a melt flow rate of 200 to 1,200 g/10 minutes include copolymers of ethylene with octene, such as AFFINITY GA1900 (trade name), AFFINITY GA1950 (trade name), and AFFINITY EG8185 (trade name), manufactured by The Dow Chemical Company.

Examples of (A4) having a melt flow rate of 200 to 1,200 g/10 minutes include copolymers of ethylene with vinyl acetate, such as Ultracene 722 (trade name) manufactured by TOSOH Corporation and Evaflex 210 (trade name) manufactured by DuPont; copolymers of ethylene with methyl methacrylate, such as ACRYFT CM5021 (trade name) and ACRYFT CM5022 (trade name) manufactured by Sumitomo Chemical Co., Ltd.

In the present invention, the polyester polyol (B) is a “main chain type” polyester and is a compound having an ester bond and a hydroxyl group in the “main chain”, and there is no particular limitation as long as the objective hot melt adhesive according to the present invention can be obtained.

A glass transition point of the polyester polyol (B) is preferably 30° C. or lower, more preferably from −70° C. to 30° C., and most preferably from −60° C. to 25° C. When the polyester polyol (B) has the glass transition point within the above range, the hot melt adhesive according to the present invention is more excellent in adhesion in a wide temperature range.

As used herein, the glass transition point is a temperature of an inflection point of a DSC curve which is obtained by measuring 5 to 10 mg of a sample at a temperature rise rate of 5° C./min using a differential scanning calorimeter (specifically, DSC6220 (trade name) manufactured by SII NanoTechnology Inc.).

In the present invention, the number average molecular weight of the polyester polyol (B) is preferably from 2,000 to 10,000, more preferably from 2,000 to 8,000, and most preferably from 2,500 to 7,000. When the polyester polyol (B) has the number average molecular weight within the above range, the hot melt adhesive according to the present invention is excellent in adhesion to a paper and is also excellent in low temperature coatability.

As used herein, the number average molecular weight is measured by gel permeation chromatography (GPC). Details of the measurement of the number average molecular weight of the polyester polyol (B) are the same as those in the case of the measurement of the above-mentioned weight average molecular weight of the ethylene-based copolymer (A).

The polyester polyol (B) can be obtained, for example, by a condensation polymerization reaction of a low molecular weight polyol with dicarboxylic acid or an anhydride thereof.

The low molecular weight polyol is preferably a polyol having 1 to 3 functional groups, and particularly preferably a difunctional polyol, that is, so-called diol. These polyols can be used alone or in combination.

Examples of the diol include low molecular weight diols such as ethylene glycol, 1-methylethylene glycol, 1-ethylethylene glycol, propylene glycol, butanediol, pentanediol, hexanediol, heptanediol, octanediol, nonanediol, decanediol, neopentyl glycol, 2-methyl-1,3-propanediol, cyclohexanedimethanol, 2,4-dimethyl-1,5-pentanediol, and 2,4-dibutyl-1,5-pentanediol.

In the present invention, the diol preferably contains at least one selected from ethylene glycol, neopentyl glycol, and hexanediol.

Examples of the dicarboxylic acid include oxalic acid, malonic acid, succinic acid, glutaric acid, adipic acid, pimelic acid, suberic acid, azelaic acid, sebacic acid, dodecanedioic acid, 2-methylsuccinic acid, 2-methyladipic acid, 3-methyladipic acid, 3-methylpentanedioic acid, 2-methyloctanedioic acid, 3,8-dimethyldecanedioic acid, 3,7-dimethyldecanedioic acid, phthalic acid, terephthalic acid, isophthalic acid, naphthalenedicarboxylic acid, trimellitic acid, trimesic acid, cyclohexanedicarboxylic acid and the like. These dicarboxylic acids are used alone or in combination.

Examples of the carboxylic anhydride include acetic anhydride, propionic anhydride, succinic anhydride, maleic anhydride, and phthalic anhydride. These carboxylic anhydrides can be used alone or in combination.

In the present invention, these dicarboxylic acids and anhydrides thereof preferably contain at least one selected from phthalic acids such as phthalic acid, terephthalic acid, isophthalic acid, and phthalic anhydride; and adipic acids such as 2-methyladipic acid and 3-methyladipic acid.

In the present invention, the wax (C) includes both (C1) a Fischer-Tropsch wax which is one of synthetic waxes, and (C2) a petroleum wax which is one of natural waxes.

As used herein, the “wax” means an organic substance which is solid at normal temperature and becomes liquid when heated, and is commonly regarded as a “wax”, and there is no particular limitation as long as it has waxy properties and the hot melt adhesive according to the present invention can be obtained. As mentioned above, the wax has a weight average molecular weight of less than 10,000.

The Fischer-Tropsch wax (C1) means a wax which is synthesized by the Fischer-Tropsch method and is commonly regarded as a Fischer-Tropsch wax. The Fischer-Tropsch wax is obtained by separating a wax from a wax in which component molecules have comparatively wide carbon number distribution such that component molecules have comparatively narrow carbon number distribution. Typical Fischer-Tropsch waxes include Sasol H1 (trade name) and Sasol C80 (trade name), both of which being commercially available from Sasol Wax Corporation.

Examples of the petroleum wax (C2) include paraffin wax, microcrystalline wax, and petrolatum.

The paraffin wax is a wax which is solid at normal temperature, produced by separating from vacuum distillation extract oil. Typical paraffin wax includes Paraffin Wax Series manufactured by NIPPON SEIRO CO., LTD.

The microcrystalline wax is a wax which is solid at normal temperature, produced by separating from a vacuum distillation bottom or heavy extract oil. Typical microcrystalline wax includes Hi-Mic Series manufactured by NIPPON SEIRO CO., LTD.

The petroleum is a wax which is semi-solid at normal temperature, produced by separating from a vacuum distillation bottom. Typical petrolatum includes Centon CP Series manufactured by CHUO YUKA Co., LTD. In the present invention, the petroleum wax (C2) is preferably paraffin wax or microcrystalline wax.

In the present invention, the wax (C) may contain, in addition to the Fischer-Tropsch wax (C1) or the petroleum wax (C2), synthetic waxes such as polyolefin wax (for example, polyethylene wax, polypropylene wax, polyethylene/polypropylene wax); and natural waxes such as caster wax.

In addition to the components (A), (B), and (C), the hot melt adhesive according to the present invention may preferably contain (D) a tackifier. When the hot melt adhesive contains (D) a tackifier resin, low temperature coatability and adhesion to a paper are more improved while maintaining thermal stability.

There is no particular limitation on the “tackifier resin” as long as it is commonly used in the hot melt adhesive, and the objective hot melt adhesive according to the present invention can be obtained.

Examples of the tackifier resin include, a natural rosin, a modified rosin, a hydrogenated rosin, a glycerol ester of a natural rosin, a glycerol ester of a modified rosin, a pentaerythritol ester of a natural rosin, a pentaerythritol ester of a modified rosin, a pentaerythritol ester of a hydrogenated rosin, a copolymer of a natural terpene, a terpolymer of a natural terpene, a hydrogenated derivative of a copolymer of a hydrogenated terpene, a polyterpene resin, a hydrogenated derivative of a phenol-based modified terpene resin, an aliphatic petroleum hydrocarbon resin, a hydrogenated derivative of an aliphatic petroleum hydrocarbon resin, an aromatic petroleum hydrocarbon resin, a hydrogenated derivative of an aromatic petroleum hydrocarbon resin, a cyclic aliphatic petroleum hydrocarbon resin, and a hydrogenated derivative of a cyclic aliphatic petroleum hydrocarbon resin. These tackifier resins can be used alone or in combination. A liquid type tackifier resin can be used as long as the tackifier resin has a colorless to pale yellow color tone and is substantially free from odor, and also has satisfactory thermal stability. Taking these characteristics into consideration comprehensively, hydrogenated derivatives of the above-mentioned resins are preferable as the tackifier resin.

Commercially available products can be used as the tackifier resin. Examples of the commercially available products include ECR5600 (trade name) manufactured by Exxon Mobil Corporation; MARUKACLEAR H (trade name) manufactured by Maruzen Petrochemical CO, LTD.; CLEARON K100 (trade name) manufactured by YASUHARA CHEMICAL CO., LTD.; Alkon M100 (trade name) manufactured by Arakawa Chemical Industries, Ltd.; I-MARV S100 (trade name) and I-MARV Y135 (trade name) manufactured by Idemitsu Petroleum Chemical Co., Ltd.; CLEARON K4090 (trade name) and CLEARON K4100 manufactured by YASUHARA CHEMICAL CO., LTD.; ECR231C (trade name) and ECR179EX (trade name) manufactured by Exxon Mobil Corporation; and Rigarite R7100 (trade name) manufactured by Eastman Chemical Company. These commercially available tackifier resins can be used alone or in combination.

The hot melt adhesive according to the present invention preferably contains a tackifier resin (D) in the amount of 40 to 100 parts by weight, and more preferably 50 to 80 parts by weight, based on 100 parts by weight of the total weight of the components (A) to (C).

When the hot melt adhesive according to the present invention contains the components (A) to (D) in the above proportions, the hot melt adhesive is more suited to low temperature coating, also has suitably long open time and is more excellent in adhesion to a paper, and the hot melt adhesive can also be used for assembling a special carton coated with a chemical.

The hot melt adhesive according to the present invention may further contain various additives, if necessary. Examples of the various additives include plasticizers, ultraviolet absorbers, antioxidants, stabilizers, and fine particle fillers.

There is no particular limitation on the “plasticizer”, as long as the plasticizer is mixed for the purpose of decreasing a melt viscosity of a hot melt adhesive, imparting flexibility and improving wetting to an adherend and is compatible with an ethylene-based copolymer, and also the objective hot melt adhesive according to the present invention can be obtained. Examples of the plasticizer include paraffin-based oil, naphthene-based oil and aromatic-based oil. Colorless and odorless paraffin-based oil is particularly preferable.

Commercially available products can be used as the plasticizer. Examples thereof include White Oil Broom 350 (trade name) manufactured by Kukdong Oil & Chemical Co., Ltd.; Diana Frecia S32 (trade name), Diana Process Oil PW-90 (trade name) and DN Oil KP-68 (trade name) manufactured by Idemitsu Kosan Co., Ltd.; Enerper M1930 (trade name) manufactured by BP Chemicals Ltd.; Kaydol (trade name) manufactured by Crompton Corporation; and Primol 352 (trade name) manufactured by Esso Corporation. These plasticizers can be used alone or in combination.

The “stabilizer” is mixed so as to improve stability of the hot melt adhesive by preventing decrease in molecular weight due to heat, as well as occurrence of gelation, coloration and odor of the hot melt adhesive. There is no particular limitation on the stabilizer, as long as the objective hot melt adhesive according to the present invention can be obtained. Examples of the stabilizer include an antioxidant and an ultraviolet absorber.

The “ultraviolet absorber” is used so as to improve light resistance of the hot melt adhesive. The “antioxidant” is used so as to depress oxidative degradation of the hot melt adhesive. There is no particular limitation on the antioxidant and ultraviolet absorber, as long as they are generally used in hot melt adhesives, and below-mentioned objective paper products can be obtained.

Examples of the “antioxidant” include a phenol-based antioxidant, a sulfur-based antioxidant, and a phosphorus-based antioxidant. Examples of the ultraviolet absorber include a benzotriazole-based ultraviolet absorber and a benzophenone-based ultraviolet absorber. A lactone-based stabilizer can also be added. These antioxidants and ultraviolet absorbers can be used alone or in combination.

It is possible to use, as the stabilizer, commercially available products. Examples thereof include SUMILIZER GM (trade name), SUMILIZER TPD (trade name) and SUMILIZER TPS (trade name) manufactured by Sumitomo Chemical Company; Limited, IRGANOX 1010 (trade name), IRGANOX HP2225FF (trade name), IRGAFOS 168 (trade name) and IRGANOX 1520 (trade name) manufactured by Ciba Specialty Chemicals Co., Ltd.; and JF77 (trade name) manufactured by Johoku Chemical Co., Ltd. These stabilizers can be used alone or in combination.

The hot melt adhesive according to the present invention can further contain a fine particle filler. There is no particular limitation on the fine particle filler, as long as it is generally used and the objective hot melt adhesive according to the present invention can be obtained. Examples of the “fine particle filler” include mica, calcium carbonate, kaolin, talc, titanium oxide, diatomaceous earth, urea-based resin, styrene beads, baked clay, starch and the like. The shape of these fine particle fillers is preferably spherical. There is no particular limitation on the size (diameter in case of a spherical).

Melt viscosity at 130° C. of the hot melt adhesive according to the present invention is preferably from 400 to 2,000 mPa·s. When the melt viscosity at 130° C. is within the above range, applicability at 130° C. of the hot melt adhesive is improved, and also adhesion to a paper or thermal stability is maintained. As used herein, the melt viscosity at 130° C. means a value measured by a rotor No. 27 using a Brookfield viscometer and a thermo-cell.

The hot melt adhesive according to the present invention can be produced by mixing an ethylene-based copolymer (A), a polyester polyol (B), and a wax (C) and, if necessary, a tackifier resin (D) and various additives using a generally known method for producing a hot melt adhesive. For example, it can be produced by mixing the above-mentioned components in a predetermined amount, and heating and melting the mixture. There is no particular limitation on the order of adding each component, heating method and the like, as long as the objective hot melt adhesive can be obtained.

The hot melt adhesive according to the present invention can take various forms and is commonly in the form of a block or a film (sheet). The hot melt adhesive in the form of a block can be obtained by solidifying the product obtained by the above production method with cooling, while the hot melt adhesive in the form of a film (sheet) can be obtained by further forming the product obtained by the above method into a film.

The hot melt adhesive according to the present invention can be used by being applied to an adherend. It is not necessary to mix an organic solvent in the hot melt adhesive in coating, and therefore the hot melt adhesive is environmentally preferable.

There is no particular limitation on the coating method, and generally known method of applying (coating) of a hot melt adhesive can be used. The coating method is, for example, roughly classified into contact coating and non-contact coating. The “contact coating” means a coating method in which a dispenser is brought into contact with a member or a film in application of a hot melt adhesive, whereas, the “non-contact coating” means a coating method in which a dispenser is not brought into contact with a member or a film in application of a hot melt adhesive. Examples of the contact coating method include a slot coater coating and a roll coater coating. Examples of the non-contact coating method include a spiral coating method capable of spiral coating; omega coating and control seam coating methods capable of wavy coating; slot spray coating and curtain spray coating methods capable of planar coating; a dot coating method capable of spot-like coating; a bead coating method capable of linear coating; and the like.

The hot melt adhesive according to the present invention is applied to a base material at low temperature of about 130° C. by the above-mentioned coating method.

The hot melt adhesive according to the present invention is widely used, for example, in electronic components, woodworking, building materials, sanitary materials, paper product and the like, and can be suitably used so as to produce a paper product and it is particularly useful as a hot melt adhesive for paper products.

The paper product according to the present invention means a paper product produced by using the above-mentioned hot melt adhesive. There is no particular limitation on the kind of the paper product, as long as the paper product is produced by using the above-mentioned hot melt adhesive. Specific examples thereof include bookbinding, calendar, corrugated cardboard, carton and the like.

One preferred embodiment of the paper product according to the present invention includes a carton whose surface is coated with a chemical so as to impart a luxurious feel to wrapping of products.

Main embodiments of the present invention are shown below.

1. A hot melt adhesive comprising: (A) an ethylene-based copolymer; (B) a polyester polyol; and (C) a wax, wherein the wax (C) includes both (C1) a Fischer-Tropsch wax and (C2) a petroleum wax.
2. The hot melt adhesive according to the above 1, wherein the petroleum wax (C2) includes at least one′ selected from a paraffin wax and a microcrystalline wax.
3. The hot melt adhesive according to the above 1 or 2, wherein the ethylene-based copolymer (A) includes at least one selected from a copolymer of ethylene/olefin having 3-20 carbons and a copolymer of ethylene/carboxylic acid ester.
4. A paper product obtainable by using the hot melt adhesive according to any one of the above 1 to 3.

### Examples

The present invention will be described below by way of Examples and Comparative Examples, but the present invention is not limited to these Examples. Components of hot melt adhesives are shown below.

(A) Ethylene-Based Copolymer

(A1) Copolymer of Ethylene with Olefin

(A1-1) Ethylene/octene copolymer (weight average molecular weight: 43,000, 1-octene content: 35 to 37% by weight, melt flow rate: 500, manufactured by The Dow Chemical Company under the trade name of AFFINITY GA1950)

(A1-2) Ethylene/octene copolymer (weight average molecular weight: 38,000, 1-octene content: 35 to 37% by weight, melt flow rate: 1,000, manufactured by The Dow Chemical Company under the trade name of AFFINITY GA1900)

(A1-3) Copolymer of propylene with ethylene and 1-butene (weight average molecular weight: 34,000, glass transition point: −28° C., softening point: 124° C., melt viscosity at 190° C.: 2,700 mPa·s, manufactured by EVONIK DEGUSSA under the trade name of VESTPLAST703)

(A4) Copolymer of Ethylene with Carboxylic Acid Ester

(A4-1) Ethylene/vinyl acetate copolymer (weight average molecular weight: 59,000, vinyl acetate content: 28% by weight, melt flow rate: 400, manufactured by TOSOH Corporation under the trade name of Ultracene 722)

(A4-2) Ethylene/methyl methacrylate copolymer (weight average molecular weight: 71,000, methyl methacrylate content: 32% by weight, melt flow rate: 450, manufactured by Sumitomo Chemical Co., Ltd. under the trade name of ACRYFT CM5022)

(A4-3) Ethylene/methyl acrylate copolymer (weight average molecular weight: 68,000, methyl acrylate content: 28% by weight, melt flow rate: 250, manufactured by The Dow Chemical Company under the trade name of NUC-6070)

(B) Polyester Polyol

(B1) Copolymer of terephthalic acid, phthalic anhydride and adipic acid with ethylene glycol (number average molecular weight: 3,500, glass transition point: −31° C., manufactured by HOKOKU Co., Ltd. under the trade name of HS Polyol 2000)

(B2) Copolymer of adipic acid, isophthalic acid and terephthalic acid with neopentyl glycol and ethylene glycol (number average molecular weight: 3,000, glass transition point: 20° C., manufactured by HOKOKU Co., Ltd. under the trade name of HS Polyol 1000)

(B3) Copolymer of adipic acid with neopentyl glycol, ethylene glycol and hexanediol (number average molecular weight: 5,500, glass transition point: −50° C., manufactured by HOKOKU Co., Ltd. under the trade name of HS 2E-581A)

(B4) Copolymer of adipic acid with hexanediol (number average molecular weight: 3,500, glass transition point: −57° C., manufactured by HOKOKU Co., Ltd. under the trade name of HS 2H-351A)

(C) Wax

(C1) Fischer-Tropsch wax (weight average molecular weight: 800, softening point: 80° C., penetration degree: 7 or less, manufactured by Sasol Corp. under the trade name of Sasol C80)

(C2-1) Petroleum wax, paraffin wax (weight average molecular weight: 460, softening point: 66° C., penetration degree: 12, manufactured by NIPPON SEIRO CO., LTD under the trade name of Paraffin Wax-150)

(C2-2) Petroleum wax, microcrystalline wax (weight average molecular weight: 800, softening point: 88° C., penetration degree: 6, manufactured by NIPPON SEIRO CO., LTD under the trade name of Hi-MiC-1090)

(D) Tackifier Resin

(D1) Thermoplastic hydrocarbon resin (softening point: 100° C., manufactured by Exxon Mobil Corporation under the trade name of ECR-179EX)

(D2) Aliphatic hydrocarbon resin (softening point: 90° C., manufactured by Zeon Corporation under the trade name of Quinton DX390N)

According to formulations shown in Tables 1 to 4, these components were melted and mixed at about 145° C. over about 1 hour using a universal stirrer to prepare hot melt adhesives of Examples 1 to 12, and Comparative Examples 1 to 4.

With respect to the above hot melt adhesives, melt viscosity, low temperature coatability, open time, and adhesion were evaluated.

The hot melt adhesive was applied to a K liner corrugated cardboard to obtain samples for evaluating the low temperature coatability and the open time. Summaries of each evaluation are described below.

<Melt Viscosity>

### (Test Method)

Using a Brookfield viscometer and a thermo-cell, melt viscosity at 130° C. was measured.

<Low Temperature Coatability>

### (Test Method)

A hot melt adhesive melted at 130° C. was applied to a K liner corrugated cardboard in a coating amount of 2 g/m, and then the K liner corrugated cardboard was laminated to the other K liner corrugated cardboard under the conditions of a setting time of 10 seconds and a pressing pressure of 1 kg/25 cm². After forcibly peeling, a spreading state of the hot melt adhesive was measured.

A: Spread of hot melt adhesive was more than 10 mm.

B: Spread of hot melt adhesive was from 8 to 10 mm.

C: Spread of hot melt adhesive was less than 8 mm.

<Open Time>

### (Evaluation Method)

A hot melt adhesive melted at 130° C. was applied to a K liner corrugated cardboard in a coating amount of 2 g/m, and then the K liner corrugated cardboard was laminated to the other K liner corrugated cardboard under the conditions of a setting time of 10 seconds and a pressing pressure of 1 kg/25 cm². A time in which bonding can be performed was measured.

A: Open time was longer than 12 seconds.
B: Open time was from 10 to 12 seconds.
C: Open time was shorter than 10 seconds.

<Adhesion>

### (Preparation of Samples)

A hot melt adhesive was melted at 130° C. and applied in a coating amount of 2 g/m to each of a carton having a surface which is not treated with a surface treating agent, and a carton having a surface treated with a surface treating agent. A sample was prepared by laminating each of the cartons under the conditions of a set time of 1 second and an open time of 5 seconds under a pressurizing pressure of 1 kg/25 cm².

### (Evaluation Method)

Each prepared sample was aged in a constant temperature bath set to 40° C., 23° C., 0° C., −10° C., or −20° C. for 24 hours, and then two cartons were forcibly peeled by hands under the atmosphere. The proportion of fractured portion(s) (material fracture ratio) was examined by visually observing the state of the peeled surface. The proportion of the area of the fractured carton in the total bonding area was regarded as a proportion of a fractured portion(s) of material (material fracture ratio).

A: A material fracture ratio was more than 80%.

B: A material fracture ratio was from 65% to 80%.

C: A material fracture ratio was less than 65%.

TABLE 1

| | | Example 1 | Example 2 | Example 3 | Example 4 | Example 5 |
|---|---|---|---|---|---|---|
| (A) | (A1-1) | 52 | | | | |
| | (A1-2) | | 52 | | | |
| | (A1-3) | | | | | |
| | (A4-1) | | | 52 | | |
| | (A4-2) | | | | 52 | |
| | (A4-3) | | | | | 52 |
| (B) | (B1) | 6 | 6 | 6 | 6 | 6 |
| | (B2) | | | | | |
| | (B3) | | | | | |
| | (B4) | | | | | |
| (C) | (C1) | 21 | 21 | 21 | 21 | 21 |
| | (C2-1) | 21 | 21 | 21 | 21 | 21 |
| | (C2-2) | | | | | |
| Total of | | 100 | 100 | 100 | 100 | 100 |
| (A) to (C) | | | | | | |
| (D) | (D1) | 42 | 42 | 42 | 42 | 42 |
| | (D2) | 31 | 31 | 31 | 31 | 31 |

| | | | | | |
|---|---|---|---|---|---|
| Total amount | 173 | 173 | 173 | 173 | 173 |
| of (A) to (D) | | | | | |
| Melt | | | | | |
| viscosity | | | | | |
| (mPa · s) | | | | | |
| 120° C. | 1,750 | 1,370 | 2,590 | 2,360 | 2,630 |
| 130° C. | 1,260 | 980 | 1,820 | 1,650 | 1,870 |
| 140° C. | 930 | 720 | 1,310 | 1,180 | 1,410 |
| Low | A | A | B | A | B |
| temperature | | | | | |
| coatability | | | | | |
| Open time | A | A | A | A | B |
| Adhesion | | | | | |
| (Surface | | | | | |
| untreated | | | | | |
| base | | | | | |
| material) | | | | | |
| 40° C. | A | A | A | A | A |
| 23° C. | A | A | A | A | A |
| 0° C. | A | A | A | A | A |
| −10° C. | A | A | A | A | A |
| −20° C. | A | A | B | A | B |
| Adhesion | | | | | |
| (Surface | | | | | |
| treated | | | | | |
| base | | | | | |
| material) | | | | | |
| 40° C. | A | A | A | A | A |
| 23° C. | A | A | A | A | A |
| 0° C. | A | A | A | A | A |
| −10° C. | A | A | B | A | B |
| −20° C. | A | A | B | B | B |

TABLE 2

| | | | | | | Example |
|---|---|---|---|---|---|---|
| | | Example 6 | Example 7 | Example 8 | Example 9 | 10 |
| (A) | (A1-1) | | 48 | 52 | 52 | 52 |
| | (A1-2) | | | | | |
| | (A1-3) | 52 | | | | |
| | (A4-1) | | | | | |
| | (A4-2) | | 4 | | | |
| | (A4-3) | | | | | |
| (B) | (B1) | 6 | 6 | | | |
| | (B2) | | | 6 | | |
| | (B3) | | | | 6 | |
| | (B4) | | | | | 6 |
| (C) | (C1) | 21 | 21 | 21 | 21 | 21 |
| | (C2-1) | 21 | 21 | 21 | 21 | 21 |
| | (C2-2) | | | | | |
| Total of | | 100 | 100 | 100 | 100 | 100 |
| (A) to (C) | | | | | | |
| (D) | (D1) | 42 | 42 | 42 | 42 | 42 |
| | (D2) | 31 | 31 | 31 | 31 | 31 |

| | | | | | |
|---|---|---|---|---|---|
| Total amount | 173 | 173 | 173 | 173 | 173 |
| of (A) to (D) | | | | | |
| Melt | | | | | |
| viscosity | | | | | |
| (mPa · s) | | | | | |
| 120° C. | 970 | 1,870 | 1,830 | 1,700 | 1,790 |
| 130° C. | 520 | 1,350 | 1,320 | 1,300 | 1,350 |
| 140° C. | 370 | 980 | 930 | 900 | 900 |
| Low | A | A | A | A | A |
| temperature | | | | | |
| coatability | | | | | |
| Open time | A | B | A | A | B |
| Adhesion | | | | | |
| (Surface | | | | | |
| untreated | | | | | |
| base | | | | | |
| material) | | | | | |
| 40° C. | A | A | A | A | A |
| 23° C. | A | A | A | A | A |
| 0° C. | A | A | A | A | A |
| −10° C. | B | A | B | B | A |
| −20° C. | B | B | B | B | B |
| Adhesion | | | | | |
| (Surface | | | | | |
| treated | | | | | |
| base | | | | | |
| material) | | | | | |
| 40° C. | A | A | A | A | B |
| 23° C. | A | A | A | A | A |
| 0° C. | A | A | A | A | A |
| −10° C. | B | A | B | B | B |
| −20° C. | B | B | B | B | B |

TABLE 3

| | | Example 11 | Example 12 |
|---|---|---|---|
| (A) | (A1-1) | 52 | 52 |
| | (A1-2) | | |
| | (A1-3) | | |
| | (A4-1) | | |
| | (A4-2) | | |
| | (A4-3) | | |
| (B) | (B1) | 6 | 6 |
| | (B2) | | |
| | (B3) | | |
| | (B4) | | |
| (C) | (C1) | 21 | 21 |
| | (C2-1) | | 11 |
| | (C2-2) | 21 | 10 |
| Total of (A) to (C) | | 100 | 100 |
| (D) | (D1) | 42 | 42 |
| | (D2) | 31 | 31 |

| | | |
|---|---|---|
| Total amount of (A) to (D) | 173 | 173 |
| Melt viscosity (mPa · s) | | |
| 120° C. | 2,060 | 1,850 |
| 130° C. | 1,500 | 1,370 |
| 140° C. | 1,150 | 980 |
| Low temperature coatability | A | A |
| Open time | A | A |
| Adhesion (Surface untreated base | | |
| material) | | |
| 40° C. | A | A |
| 23° C. | A | A |
| 0° C. | A | A |
| −10° C. | A | A |
| −20° C. | B | B |
| Adhesion (Surface treated base | | |
| material) | | |
| 40° C. | B | A |
| 23° C. | A | A |
| 0° C. | A | A |
| −10° C. | B | B |
| −20° C. | B | B |

TABLE 4

| | | Com- | Com- | Com- | Com- |
|---|---|---|---|---|---|
| | | parative | parative | parative | parative |
| | | Example 1 | Example 2 | Example 3 | Example 4 |
| (A) | (A1-1) | 58 | | 52 | 52 |
| | (A1-2) | | | | |
| | (A1-3) | | | | |
| | (A4-1) | | 58 | | |
| | (A4-2) | | | | |
| | (A4-3) | | | | |
| (B) | (B1) | | | 6 | 6 |
| | (B2) | | | | |
| | (B3) | | | | |
| | (B4) | | | | |
| (C) | (C1) | 21 | 21 | 42 | 42 |
| | (C2-1) | 21 | 21 | | |
| | (C2-2) | | | | |
| Total of (A) to (C) | | 100 | 100 | 100 | 100 |
| | (D1) | 42 | 42 | 42 | 42 |
| | (D2) | 31 | 31 | 31 | 31 |

| | | | | |
|---|---|---|---|---|
| Total amount of (A) to | 173 | 173 | 173 | 173 |
| (D) | | | | |
| Melt viscosity (mPa · s) | | | | |
| 120° C. | 1,810 | 2,780 | 1,770 | 1,670 |
| 130° C. | 1,370 | 2,050 | 1,330 | 1,330 |
| 140° C. | 1,070 | 1,510 | 960 | 790 |
| Low temperature | B | C | C | A |
| coatability | | | | |
| Open time | B | C | C | A |
| Adhesion (Surface | | | | |
| untreated base material) | | | | |
| 40° C. | A | B | B | C |
| 23° C. | A | B | B | B |
| 0° C. | A | C | C | B |
| −10° C. | A | C | C | B |
| −20° C. | B | C | C | C |
| Adhesion (Surface | | | | |
| treated base material) | | | | |
| 40° C. | A | B | B | C |
| 23° C. | B | C | C | B |
| 0° C. | C | C | C | B |
| −10° C. | C | C | C | C |
| −20° C. | C | C | C | C |

As shown in Tables 1 to 4, the hot melt adhesives of Examples 1 to 12 contained all of three components: (A) an ethylene-based copolymer, (B) a polyester polyol (B), and (C) a wax, the wax (C) including both (C1) a Fischer-Tropsch wax and (C2) a petroleum wax. Because of containing all of these components, the hot melt adhesives of Examples were excellent in low temperature coatability and have suitably long open time, and were also excellent in adhesion to a paper. The hot melt adhesives could maintain excellent adhesion even to a carton having a surface coated with a chemical.

To the contrary, the hot melt adhesives of Comparative Examples 1 to 4 were inferior to those of Examples in any one of performances, since they did not contain any one of (A), (B), (C1), (C2), and (D). In particular, the hot melt adhesives of Comparative Examples were drastically inferior in adhesion in a low temperature range to a carton having a surface coated with a chemical.

Therefore, the hot melt adhesives of Examples were suited for a carton, of which surface were coated with a chemical so as to impart a luxurious feel to wrapping, compared to the hot melt adhesives of Comparative Examples.

### INDUSTRIAL APPLICABILITY

The present invention provides a hot melt adhesive. The hot melt adhesive according to the present invention is suited in paper processing field, particularly production of bookbinding, calendar, corrugated cardboard, wrapping carton and the like.

1. A hot melt adhesive comprising:
(A) an ethylene-based copolymer;
(B) a polyester polyol;
(C) a mixture (C1) Fischer-Tropsch wax and (C2) a petroleum wax; and
(d) a tackifier
wherein the tackfier is present at 50 to 80 parts by weight based on 100 parts by weight of the total weight of components A, B and C.

2. The hot melt adhesive according to claim 1, wherein the petroleum wax (C2) includes at least one selected from a paraffin wax and a microcrystalline wax.

3. The hot melt adhesive according claim 1, wherein the ethylene-based copolymer (A) includes at least one selected from a copolymer of ethylene/olefin having 3-20 carbons and a copolymer of ethylene/carboxylic acid ester.

4. The hot melt adhesive according claim 1, wherein the polyol is a reaction product of a polyol and phathalic acid derivative
wherein the polyol is selected from ethylene glycol, neopentyl glycol or hexanediol; and
wherein the phathalic acid derivative is selected from the group consisting of phthalic acid, terephthalic acid, isophthalic acid, and phthalic anhydride; and adipic acids such as 2-methyladipic acid, 3-methyladipic acid, and mixtures thereof.

5. An article comprising the adhesive of claim 1, which is a paper product.
